(19) United States
(12) Patent Application Publication
(10) Pub. No.: US 2006/0065290 A1
(43) Pub. Date: Mar. 30, 2006

(54) Working surface cleaning system and method

(76) Inventors: Jerry Broz, Longmont, CO (US); Alan E. Humphrey, Livermore, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/237,596

(22) Filed: Sep. 27, 2005

Related U.S. Application Data
(60) Provisional application No. 60/614,073, filed on Sep. 28, 2004.

(51) Int. Cl. B08B 3/12

(52) U.S. Cl. 134/6; 134/1

(57) ABSTRACT

A cleaning device cleaning method is provided wherein the surface of the cleaning device is cleaned of accumulated debris and particulates.

### PRIORITY CLAIM

This application claims priority under 35 USC 119(e) to U.S. Provisional Application Ser. No. 60/614,073 filed on Sep. 28, 2004 and entitled “Working Surface Cleaning System and Method” which is incorporated herein by reference.

### FIELD OF THE INVENTION

The invention relates generally to a method for cleaning a working surface of a cleaning device and in particular to an apparatus and method for cleaning a surface of a semiconductor tester/prober cleaning device.

### BACKGROUND OF THE INVENTION

Individual semiconductor (integrated circuit) devices are typically produced by fabricating multiple devices on a wafer using well known semiconductor processing techniques including photolithography, deposition, and sputtering. Generally, these processes are intended to create multiple, fully functional integrated circuit devices prior to separating (singulating) the individual devices (dies) from the semiconductor wafer. However, in practice, physical defects in the wafer material and/or defects in the manufacturing processes invariably cause some of the individual devices to be non-functional, some of which may be repairable. It is desirable to identify the defective devices prior to separating or cutting the dies from the wafer. In particular, some product is actually repairable when the flaws are caught at the wafer lever. Other product may not be repairable but may be used in a downgraded application from the original product. This determination of the product's capabilities (a product definition provided by electrical probe testing) at the wafer level saves the manufacturer considerable cost later in the manufacturing process. In addition, product cost may be reduced if defective devices are identified.

To enable the manufacturer to achieve this testing capability, a probe card, prober and tester are employed to make temporary electrical connections to the bonding pads, solder or gold bumps or any surface on the chip where connection can be made by making manual contact to that surface. The surface may be on the individual circuit device or on multiple circuit devices when the devices are still part of a wafer. Once the connections between the tester and the circuit device are made, power and electrical signals are transferred from the tester to the device for testing to determine its functionality and whether the device is accepted or rejected for further processing. Typically, the temporary connections to the device bonding elements are made by contacting multiple electrically conductive probes (often needle like structures) against the electrically conductive bonding elements of the device. By exerting controlled pressure (downwards force on the bonding pads) of the probe tips against the bonding pads, solder balls and/or gold bumps, a satisfactory electrical connection is achieved allowing the power, ground and test signals to be transmitted.

The tester and prober need a manual interface to the bonding elements on the die to achieve contact. A probe card having a plurality of probes is used to make the connection with the bonding pads of the semiconductor die. The probes may be cantilever beams or needles or vertical beams. Typically, each probe is an inherently resilient spring device acting as a cantilever beam, or as an axially loaded column. A variation is to mount multiple probes in a spring-loaded support. In a conventional prober, the probe card, and its multiple probes, are held in precise mechanical alignment with the bonding elements of the device under test (or multiple devices, or wafer as the case may be) and the device is vertically translated into contact with the tips of the probes. In the typical prober, the tips of the probes may perform a scrubbing action in which the tip of the probes moves horizontally as it contacts the bonding pad in order to scrub away oxide, or any other material on the pad, that may inhibit the electrical contact between the probes and the bonding pads. Although the scrubbing action improves the electrical contact between the probe tip and the bonding pad, it unfortunately also generates some debris (the scraped up oxide or other debris) that may also prevent the probe tip from making a good electrical contact with the bonding pad. Alternatively, the probe tip may press vertically into the bonding pad, solder or gold bump with sufficient force to penetrate any surface material and establish good electrical contact. The probe tip may become contaminated with contaminates such as aluminum, copper, lead, tin, gold, bi-products, organic films or oxides resulting from the wafer and semiconductor device manufacturing and testing processes.

Typically, the debris generated by probing needs to be periodically removed from the probe elements to prevent a build-up which causes increased contact resistance, continuity failures and false test indications, which in turn results in artificially lower yields and subsequent increased product costs. In the industry, it has been seen that a 1% change in yield from an individual prober can equate to more than $1,000,000 per annum. Therefore, with thousands of probers operating worldwide, the impact to the industry from maintaining clean probes during testing can be very substantial. Typically, the entire probe card with the plurality of probes must be removed from the prober and cleaned or abrasively cleaned in the prober. In a typical prober, the probe card can be cleaned several times an hour, several time during a single wafer test, several times during a wafer lot, several times before lot start, and several times after lot start. Also, some operators may clean the probe several times during the initial setup of the test equipment.

To clean the prober and the probe elements, a cleaning device may be used that has a working surface attached to a wafer such as disclosed in U.S. Pat. No. 6,777,966. The cleaning device substantially cleans the probe elements while reducing debris and the like, but the polymer surface of the cleaning device eventually accumulates a substantial amount of probing debris as well as air-borne particulates. Thus, it is desirable to provide an apparatus and method for cleaning the surface of a cleaning device and it is to this end that the present invention is directed.

### SUMMARY OF THE INVENTION

A method and apparatus for cleaning the surface of a cleaning device is described. The cleaning device is designed to remove loose debris and adherent materials which are generated during a probing operation in a semiconductor manufacturing process. After repeated use, the polymer surface of the cleaning device accumulates a substantial amount of debris as well as various air-borne particulates, such as dust, skin, etc., found within a prober. The cleaning method provides a method for cleaning the surface of cleaning device so that the debris and particulate is removed from the cleaning device so that the cleaning device may be used again once it is cleaned.

In accordance with the invention, a method for cleaning the surface of a cleaning device is provided. In this method, a working surface of the cleaning device is visually inspected to detect debris associated with the working surface and the working surface is brushed with a brush when embedded debris is observed within the working surface. The working surface is then rinsed to remove other debris from the working surface and the working surface is dried following the rinsing.

In accordance with the invention, an apparatus for cleaning a cleaning device that has a working surface on top of a substrate is provided. The apparatus comprises a microscope for inspecting the working surface of the cleaning device to detect debris associated with the working surface. The apparatus further comprises a brush for brushing the working surface when debris embedded in the working surface is observed during the inspection of the working surface and a rinse device that is used to rinse the working surface to remove debris from the working surface.

### BRIEF DESCRIPTION OF THE DRAWINGS

FIG. 1 is a top view of an example of a cleaning device having a working surface that may be cleaned in accordance with the invention;

FIG. 2 is a sectional view of the cleaning device shown in FIG. 1 taken along line A-A;

FIGS. 3A-3C are diagrams illustrating a matte finish cleaning device that may be cleaned in accordance with the invention;

FIG. 4 is a diagram illustrating a conductive cleaning device that may be cleaned in accordance with the invention; and

FIG. 5 is a flowchart illustrating a method for cleaning the surface of a cleaning device in accordance with the invention.

### DETAILED DESCRIPTION OF A PREFERRED EMBODIMENT

The invention is particularly applicable to a working surface cleaning method that may be used with the prober element cleaning device described below and it is in this context that the invention will be described. It will be appreciated, however, that the method in accordance with the invention has greater utility since the method may be used to clean various different polymer surfaces.

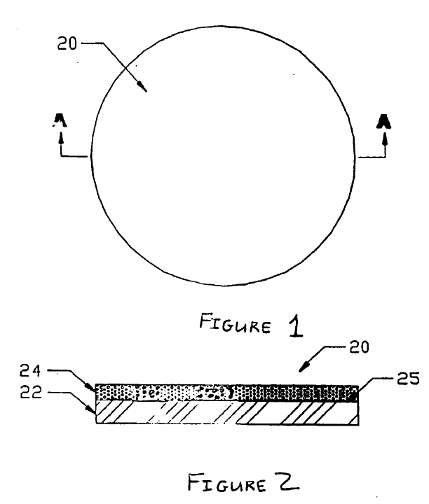

FIGS. 1 and 2 are diagrams illustrating an example of a cleaning device 20 that may be cleaned in accordance with the invention. The cleaning device 20 may be manufactured using various substrate materials, different size substrates, different shape substrates or without a substrate in some applications. As shown in FIG. 2, the cleaning device 20 may include a substrate 22 and a pad 24 secured or adhered to a surface 25 of the substrate. The substrate may be any material that can support the pad and has sufficient strength to resist breaking when the probes come into contact with the pad and generate a contact force. Thus, the substrate may be plastic, metal, glass, silicon, ceramic or any other similar material. In a preferred embodiment, the substrate 22 may be a semiconductor wafer. The wafer surface 25 onto which the pad is secured or adhered may have a flat mirror finish or a slightly abrasive roughness finish with microroughness of about 1-3 μm. The abrasive finish may burnish/abrade the probe tips during the cleaning process.

The pad 24 may be made of a material with predetermined properties that contribute to the cleaning of the probe elements tips that contact the pad. For example, the pad may have abrasive, density, elasticity, and/or tacky properties that contribute to cleaning the probe tips. The abrasiveness of the pad will loosen debris during the scrubbing action and remove unwanted material from the tips. Using a more dense material, the abrasiveness of the pad may round or sharpen the probe tips. The pad may further be used to reshape a flat probe tip into a semi-radius or a radius probe tip. Furthermore, the pad may be used to re-furbish the tip shape of “used” probe cards. Typical abrasives that may be incorporated into the pad may include aluminum oxide, silicon carbide, and diamond although the abrasive material may also be other well known abrasive materials. The abrasive may include spatially distributed particles of aluminum oxide, silicon carbide, or diamond. The tackiness of the pad may cause any debris on the probe tip to preferentially stick to the pad and therefore be removed from the probe tip. In a preferred embodiment, the pad may be made of an elastomeric material that may include rubbers and both synthetic and natural polymers. The elastomeric material may be a material manufactured with a slight tackiness or some abrasive added to the body of the material. The material may have a predetermined elasticity, density and surface tension parameters that allow the probe tips to penetrate the elastomeric material and remove the debris on the probe tips without damage to the probe tip, while retaining the integrity of the elastomeric matrix. In one example, the elastomeric material may be the Probe Clean material commercially sold by International Test Solutions, Inc. The material may have a thickness generally between 1 and 20 mils thick. The thickness of the pad may be varied according the specific configuration of the probe tip.

As the one or more probe elements of the prober contact the pad during the normal operation of the prober machine, they exert a vertical contact force to drive the probe element into the pad where the debris on the probe elements will be removed and retained by the pad material. In other embodiments of the cleaning system, the cleaning efficiency of the material can be improved with either a horizontal translation and/or an orbital motion of the cleaning unit during the probe tip cleaning operation.

The amount and size of the abrasive material added to the elastomer may vary according the configuration and material of the probe elements to achieve a pad that will remove the debris but will not damage the probe elements. The pad material and abrasiveness may be adjusted during the manufacturing of a pad when the pad is used to reshape, sharpen or refurbish the probe element tips. The same cleaning and reshaping may also be accomplished by the substrate alone.

Once the optimal probe tip shape has been established, conventional abrasive methods affect the integrity of the tip shape, probe card planarity and alignment, and, over time, degrade probe card performance and reduce probe card service life. Furthermore, these destructive cleaning methods remove material from the test probe tip and reduce the probe card life by damaging the test probe tip, degrading the electrical performance and compromising any test probe tip shape related properties. In accordance with the invention, the cleaning system and pad not only removes and collects adherent particulates from the test probe contact surface but maintains the shape and geometric properties of the test probe tip contact surface. The insertion of the test probe tips into the cleaning device 20 removes adherent debris from the probe tip length and probe beam without leaving any organic residue that must be removed. Spectral analysis shows no material transfer from the cleaning material onto the contact surface of the test probe. Furthermore, the overall probe card electrical characteristics are unaffected. Now, several other examples of cleaning devices that may be cleaned in accordance with the invention are described.

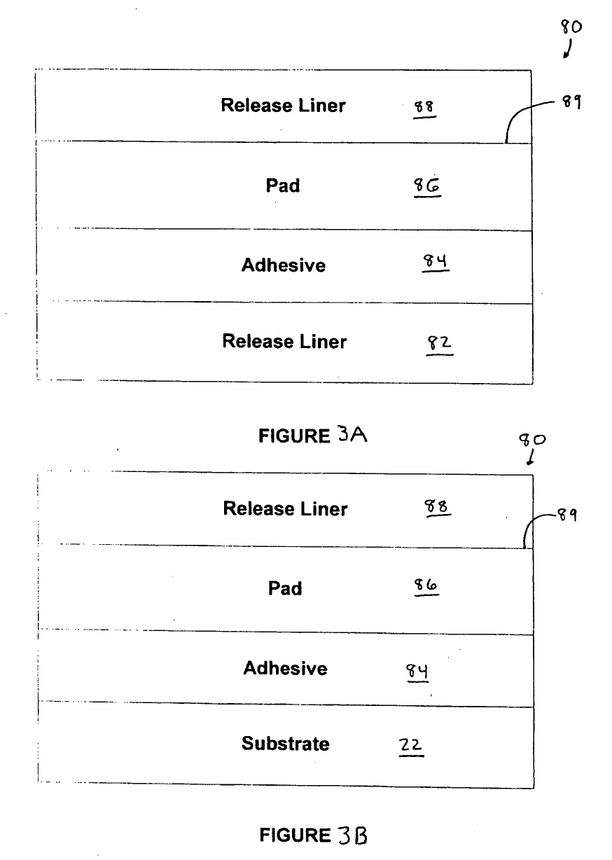

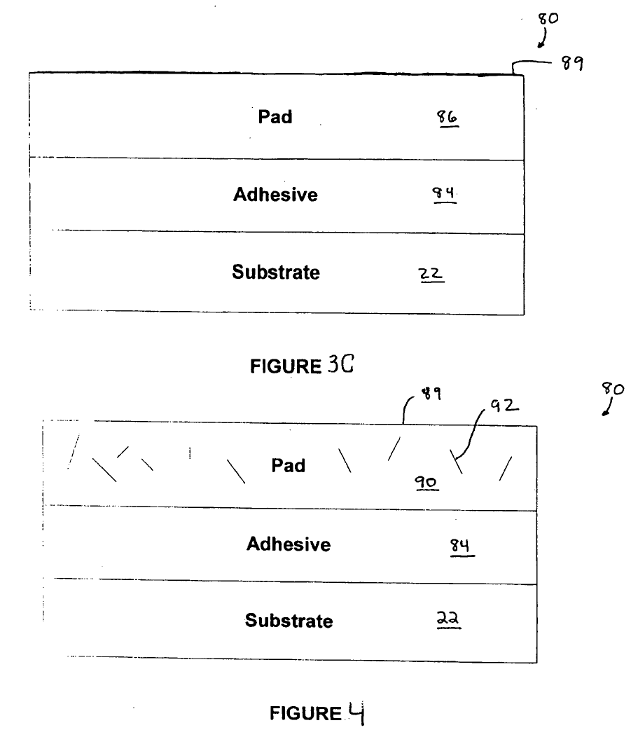

FIGS. 3A-3C are diagrams illustrating an example of a cleaning device 80 with a matte surface finish. As shown in FIG. 3A, the cleaning device 80 initially has a first release liner layer 88 that is made of a known non-reactive polymeric film material and preferably made of a polyester (PET) film. The first release liner may have a matte finish or other “textured” features to improve the optical detection of the cleaning device and/or improve cleaning efficiency. A pad layer (working surface polymer) 86 is formed on the first release liner layer 88. The pad layer 86 is then formed on top of the adhesive layer wherein the pad layer is made from an elastomeric material that may include rubbers and both synthetic and natural polymers. The elastomeric material may be manufactured with a slight tackiness or some abrasive particulates added to the body of the material. The material may have a predetermined elasticity, density, and surface tension parameters that allow the tips to penetrate the elastomeric material and remove the debris on the test probe without damage to the test probe tip, the test probe contact surface, or test probe shape, while retaining the integrity of the elastomeric matrix and without material transfer from the cleaning material onto the contact surface of the test probe. Preferably, the pad material may be Probe Clean material that is commercially available from and manufactured by International Test Solutions, Inc.

Next, an adhesive layer 84 is formed on the pad layer 86. The adhesive layer is a compound and adheres a pad layer 86 to a substrate 22 (See FIG. 3B) when the cleaning device is applied to a substrate. In one form, the adhesive layer is comprised of a resin or cross-linked compound and can have a tack value of 1 to 300 gram-force. In another form, adhesive layer is comprised of a resin or cross-linked compound that is considered to be permanent, that is, the cleaning material will be damaged before the adhesive layer is compromised. Finally, a second release liner layer 82 (made of the same material as the first release liner layer) is formed on the adhesive layer 84 wherein the second release liner layer (also known as the back release liner layer) may be subsequently removed to expose the adhesive layer 84. The first release liner layer 88 protects a working surface 89 of the pad layer 86 from debris/contaminants until the cleaning device 80 is ready to be used for cleaning a prober in a clean room. The cleaning device 80 as shown in FIG. 3A may be in the form that is shipped to an entity that uses a prober/tester.

Then, as shown in FIG. 3B, the second release liner layer 82 may be removed which exposes the adhesive layer 84. The adhesive layer 84 may then be placed against the substrate 22 to adhere the cleaning device 80 to the substrate. In accordance with the invention, the substrate may be a variety of different materials as described above which have different purposes. For example, the substrate may be a wafer, but it may also be applied to the top of the sanding/abrasion disk (such as that shown in FIG. 1) or other surfaces. As shown in FIG. 3B, the working surface 89 of the cleaning device 80 is still protected from contaminants and debris by the first release liner layer 88. When the user is ready to begin cleaning probe elements with the cleaning device 80 (and the cleaning device 80 is within the clean room with the prober/tester), the user removes the first release liner layer 88 as shown in FIG. 3C which exposes the cleaning pad layer 86 so that the prober may be cleaned. In accordance with the invention, the removal of the first release liner layer 88 leaves the working surface 89 of the cleaning pad layer with a matte finish. In the preferred embodiment, the surface finish, smoothness, texture, and/or surface morphology of the cleaning pad can be obtained, developed, or, imparted to reflect the smoothness, texture, and/or surface morphology of the release liner. Furthermore, the surface finish of the cleaning polymer, as well as, the surface finish of the release liner can be modified by solvent-induced effects.

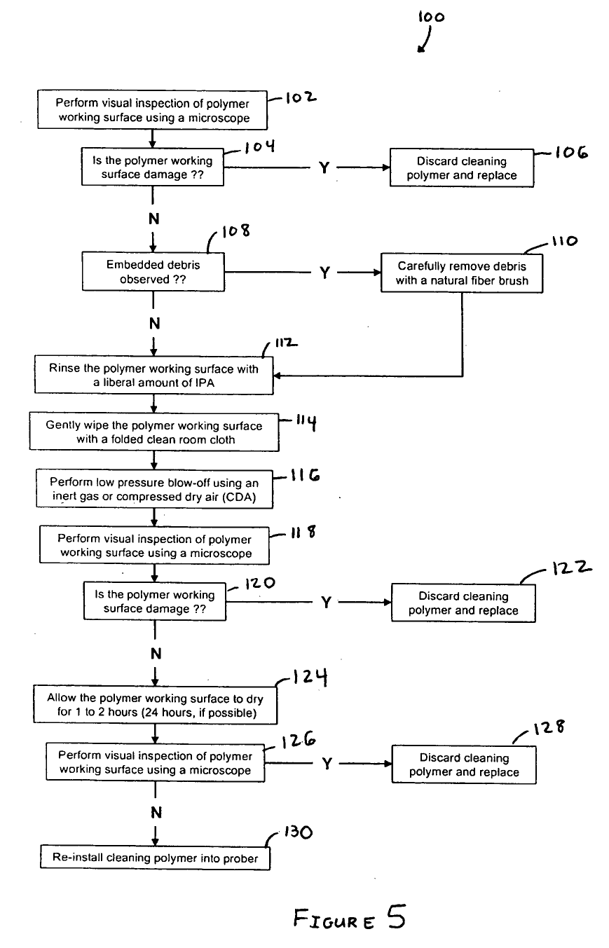

FIG. 4 is a diagram illustrating an example of a cleaning device 80 which is conductive. FIG. 4 illustrates a completed cleaning device 80 wherein the cleaning device 80 is adhered to a substrate 22 and the cleaning device 80 further comprises an adhesive layer 84 and a conductive cleaning pad layer 90. As above, the adhesive layer 84 adheres the cleaning pad layer 90 to the substrate 22. In this embodiment of the invention, the cleaning pad layer 90 is conductive so that a prober/tester that determines the location of a surface using conductance testing is able to accurately locate the working surface 89 of the cleaning pad layer 90. Thus, a prober/tester that performs a conductance test to detect a surface is able to operate in the automatic cleaning mode using the cleaning device 80 shown in FIG. 4. In accordance with the invention, the cleaning pad layer 90 may be made conductive using a variety of different methodologies. For example, the material of the cleaning pad layer 90 may include an additive which makes the cleaning pad layer 90 conductive. The conductive additive or filler may be, for example, conductive carbon-graphite particles or fibers, metal plated abrasive particulates or fibers, metallic particulates or fibers, which make the cleaning pad layer conductive. In the alternative, a well known conductive polymer material, such as polyanilenes, polypyrroles, polythiophenes, or other well known conductive polymer materials, may be used for the cleaning pad layer 90. A conductive element 92 is shown in FIG. 4 and may be implemented in various well known manners. The cleaning devices 80 shown are examples of the different cleaning devices that permit a prober/tester to detect the working surface of the cleaning device so that the tester/prober device is able to operate in an automatic cleaning mode. It is desirable to operate the prober/tester in the automatic cleaning mode which reduces the involvement of humans (and reduces the errors and contaminants) and also increases the throughput of the prober/tester.

The cleaning device described above removes loose debris and adherent materials which are generated during a probing operation in a semiconductor manufacturing process. After repeated use, the polymer surface of the cleaning device accumulates a substantial amount of debris as well as various air-borne particulates, such as dust, skin, etc., found within a prober. The cleaning method provides a method for cleaning the surface of cleaning device so that the debris and particulate is removed from the cleaning device so that the cleaning device may be used again once it is cleaned.

FIG. 5 is a flowchart illustrating a method 100 for cleaning the surface of a cleaning device in accordance with the invention. In order to perform the cleaning method described below, a user may preferably use the following materials:
Stereo Microscope
150-mm (6-inch), 200-mm (8-inch) or 300-mm (12-inch) Probe Clean™ cleaning wafer
Prober polishing, or cleaning, plate onto which the cleaning polymer material has been installed.
Latex gloves
Liquid Isopropyl alcohol (IPA), greater than 99.5% pure, anhydrous, meets SEMI base spec standards, and is labeled “electronic grade”
Lint free clean room clothes
Natural fiber brush

Returning to FIG. 5, in step 102, a careful visual inspection (preferably while wearing latex gloves to avoid contamination due to fingerprints, etc.) of the polymer working surface for any debris, defects, and damage such as tears, lifting around the edges, bubbles, shredded material, or significant surface discontinuities is performed. Preferably, the inspection is performed using a stereo microscope. During the visual inspection, it should be noted that there may be some manufacturing roller marks across the surface that can be expected. In accordance with the invention, inspection should be performed across the entire polymer surface with particular attention to the darker cleaning area to identify embedded probing debris such as aluminum “tails” and solder residuals. If excessive damage, e.g., torn area, shredded material, or other potentially hazardous to the probe card surface features, due to on-line cleaning or handling are observed in step 104, the polymer should be discarded and replaced in step 106. If embedded probing debris such as aluminum “tails” and solder residuals are observed within the polymer material in step 108, then proceed to step 110 in which the embedded debris is removed with a very light natural fiber (i.e., sable, yak, etc.) brush. During the brushing, extreme caution must be taken during the operation to avoid tearing the polymer layer as these embedded particulates are removed. After brushing the polymer surface, perform a careful visual inspection of the polymer working surface for damage such as tears, shredded material, or surface discontinuities. If excessive damage due to cleaning or handling is observed, the polymer should be discarded. Once the brushing is completed and the embedded debris is removed, the polymer surface may be rinsed and dried in step 112 and 114 which will now be described.

In step 112, if debris exists on the polymer working surface, gently flood the entire surface of the polymer with a liberal amount of IPA until it is covered with a thin layer of the liquid. Then in step 114, with a folded lint-free clean-room cloth (since paper based materials, such as towels, tissue, TEX-Wipes, etc., may not remove the IPA uniformly from the surface of the polymer material) carefully and gently wipe the IPA across the surface of the wafer in one direction to avoid redistributing debris on the polymer surface. The rinsing operation can be performed using a standard rinse bottle; however, excessive fluid pressure should not be used as excessive fluid pressure will force the IPA into any surface discontinuities and into the polymer thickness. However, prolonged exposure to liquid IPA may cause the polymer to swell and form “bumps” across the surface. In order to avoid redepositing material onto the working surface of the cleaning device, use a fresh surface of the lint free cloth with each wipe and this can be accomplished by refolding the clean-room wipe or by using a new wipe.

In step 116, the polymer surface may be dried with a low pressure blow-off across the polymer surface using an inert gas or compressed dry air (CDA). Preferably, the blow-off should not be directly perpendicular to the polymer surface. Furthermore, some forced air sources, such as pressurized canisters or “standard” house air, may contain hydrocarbon residues and are not recommended. Preferably, directing the air so that the IPA is blown from one side of the wafer to the other is suggested and using a diffuser is recommended to avoid driving the IPA into any of the surface discontinuities. In steps 118 and 120, a visual inspection of the polymer working surface for smoothness, i.e., no surface “bumps” are visible, as well as any other damage such as tears, shredded material, or significant surface discontinuities is performed. As above, if these or any other surface defects are observed, the polymer should be discarded in step 122. In step 124, the polymer surface is air-dried for at least 1 to 2 hours (24 hours, if possible) to volatilize any residual IPA from the polymer surface. Preferably, oven drying should not be used to accelerate the IPA volatilization process. In step 126, a final visual inspection of the polymer working surface for smoothness, i.e., no surface “bumps” are visible, as well as any other damage such as tears, shredded material, or significant surface discontinuities is performed. If these or any other surface defects are observed, the polymer should be discarded in step 128. In step 130, if the polymer surface is free from the aforementioned or any other defects, it can be re-installed into the prober according to recommended practices.

While the foregoing has been with reference to a particular embodiment of the invention, it will be appreciated by those skilled in the art that changes in this embodiment may be made without departing from the principles and spirit of the invention, the scope of which is defined by the appended claims.

1. A method for cleaning the surface of a cleaning device having a working surface that traps debris, the method comprising:
visually inspecting a working surface of the cleaning device to detect debris associated with the working surface, the debris including airborne debris and debris embedded into the working surface;
brushing the working surface with a brush when embedded debris is detected within the working surface;
rinsing the working surface to remove the debris from the working surface; and
drying the working surface following the rinsing.

2. The method of claim 1, wherein the drying step further comprises wiping the working surface with a cloth and blowing-off the working surface.

3. The method of claim 2, wherein the rinsing further comprises applying an isopropyl alcohol to the working surface.

4. An apparatus for cleaning a cleaning device, the cleaning device having a working surface on top of a substrate, the apparatus comprising:
a microscope for inspecting the working surface of the cleaning device to detect debris associated with the working surface;
a brush for brushing the working surface when debris embedded in the working surface is observed during the inspection of the working surface; and
a rinse device that is used to rinse the working surface to remove debris from the working surface.

5. The apparatus of claim 4, wherein the brush further comprises a natural fiber brush.

6. The apparatus of claim 4, wherein the working surface further comprises a polymer working surface.

7. The apparatus of claim 5, wherein the polymer working surface further comprises an elastomeric material.
